(19) United States
(12) Patent Application Publication
(10) Pub. No.: US 2008/0141348 A1
(43) Pub. Date: Jun. 12, 2008

(54) QoS System for Preferential Network Access

(75) Inventors: Shant Hovnanian, New York, NY (US); Marcos R. Lara, New York, NY (US)

Correspondence Address: SYNNESTVEDT LECHNER & WOODBRIDGE LLP, P O BOX 592, 112 NASSAU STREET, PRINCETON, NJ, 08542-0592, US

(73) Assignee: SPEEDUS CORP., New York, NY (US)

(21) Appl. No.: 11/856,194

(22) Filed: Sep. 17, 2007

Related U.S. Application Data
(60) Provisional application No. 60/825,760, filed on Sep. 15, 2006.

(51) Int. Cl. H04L 9/32

(52) U.S. Cl. 726/4

(57) ABSTRACT

A system and method of securely sharing wireless access points that that guarantees a privileged set of users a pre-selected quality of service (QOS) when using a particular access point. Client modules running on the end-user's wireless computer effectively act as firewalls and make the method independent of the access point hardware or firmware. A network wireless access point owner sets up the access preferences for the different classes of users via a control portal and an authentication server. Access options include no access by guest users, or a restriction to a predetermined percentage of the bandwidth, when the access point is being used by the owner.

### CROSS REFERENCE TO RELATED APPLICATIONS

This application is related to, and claims priority from, U.S. Provisional Patent application No. 60/825,760 filed on Sep. 15, 2007, by M. Lara et al entitled “QoS System for Preferential Network Access”, the contents of which are hereby incorporated by reference.

### FIELD OF THE INVENTION

The present invention relates to systems and methods for managing wireless access points and particularly to systems and methods that allow shared, secure access to wireless networks while providing a guaranteed quality of service to one or more privileged users of the system.

### BACKGROUND OF THE INVENTION

A growing trend in wireless access use is for communities of users to facilitate shared, secure access to wireless access points among their own members.

When wireless access points are shared on this basis, each access point is typically owned by a member of the community, and made available to other members of the community via a shared authentication server. One issue that arises in such communities is that while members are willing to share access to a network with other community members when they are not themselves using their access point, they want a guaranteed quality of service when they, or privileged users such as their immediate family or friends, use the access point. Guarantying this quality of service may necessitate making the access point unavailable to other members of the community when the owner, or their immediate family or friends, are using the access points.

A technical problem that arises in attempting to implement such preferred network access is that most commonly used consumer grade wireless access points, or wireless routers, do not support the features, such as bandwidth throttling, that would allow such controlled access.

Although the necessary features can be added to many consumer grade access points by flashing the access point, i.e., by downloading additional software into the access points flash memory, such a procedure is different for each different access point, and if done incorrectly, can turn the access point into what is colloquially termed “a brick”, i.e. a non-functioning device.

What is needed is a way of implementing shared, secure use of wireless access points that allow pre-selected classes of users a guaranteed quality of service (QOS) that does not depend on features in the wireless access points themselves to provide any user differentiation.

### SUMMARY OF THE INVENTION

Briefly described, the invention provides a system and method of securely sharing wireless access points that allows preferential network access by a privileged set of users that guarantees them a pre-selected quality of service (QOS) when using a particular access point. The QOS system for preferential network access of this invention makes use of client modules and is independent of the functionality of the access point hardware or firmware.

In a preferred embodiment of the system, an owner of a network wireless access point sets up the preferences for access by different classes of users including, but not limited to, themselves, their friends and guests belonging to a community of users. These preferences are set by accessing a control portal that manages the community access and an authentication server associated with the control portal. The access options may include, but are not limited to, options such as no access by other community guest users when the access point is being used by the owner, or a restriction to a predetermined percentage of the available bandwidth for all guest users when the owner is using the access point. The preferences may also include defining other classes of users, such as, but not limited to, a list of friends or a preferred user access control list that defines a list of users have another level of access privileges that may be the same as the owner's, or may differ from either the owner's or the guests' access privileges.

The community of users typically all have client software modules that allow them access to community access points. These client modules communicate with an authentication server database to establish secure access over the community access points. If, however, the database shows that the owner of the access point is currently accessing the network via that access point, the owner's preferences will be implemented, including, if appropriate, denial of access at that time to other community users or only allowing the guest users a predetermined total percentage of the access points bandwidth.

In a preferred embodiment of the invention, this implementation may be done by the client software module running on the end-user's wireless computer effectively acting as a firewall, or it may be done by the client software module invoking a firewall running on the end-user's wireless computer.

These and other features of the invention will be more fully understood by references to the following drawings.

### BRIEF DESCRIPTION OF THE DRAWINGS

FIG. 1 is schematic diagram showing a securely shared network access point in accordance with a preferred embodiment of the present invention.

FIG. 2 is an interaction diagram showing a schematic representation of steps involved in implementing a preferred embodiment of the present invention.

### DETAILED DESCRIPTION

The present invention applies to systems and methods for securely sharing access to a network, and is particularly applicable to securely sharing wireless network access points in a controlled, secure manner in a way that allows predefined classes of users differing access privileges.

The present invention addresses the problem of how to share access in way that is not a “free for all” when the router providing the wireless network access does not have the required functionality to provide the required managed access.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

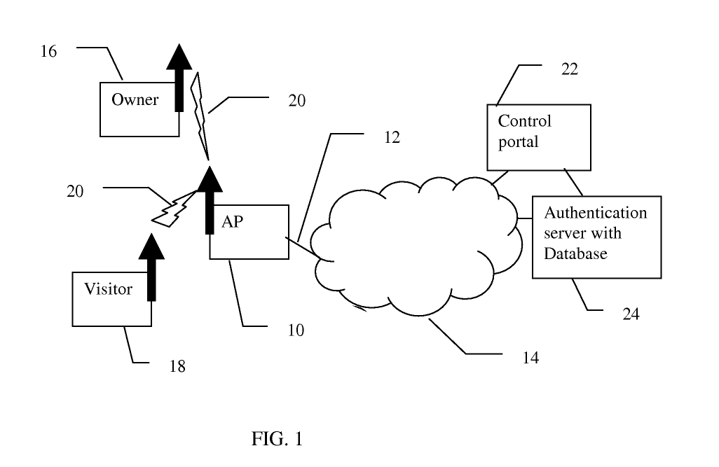

FIG. 1 is schematic diagram showing a securely shared network access point 10 in accordance with a preferred embodiment of the present invention.

The network access point 10 is typically a wireless router that provides a high speed link 12 link to a network 14. The high speed link 12 may, for instance, include a cable modem and a cable link, or a fiber optic link. The network 14 may be the Internet, the worldwide web or some local, wide area network or wireless wide area network (LAN, WAN or WWAN). The network access point 10 facilitates wireless access to an owner's computer 16. The wireless access may be made using a wireless protocol such as, but not limited to, the 802.11(a.k.a. Wifi) protocol, and may be made secure using encryption such as, but limited to WEP or WPA encryption.

In a preferred embodiment of the invention, the network access point 10 owner may desire to share their secure access to the network 14 with other people. This may be done via membership of a community such as, but not limited to the Wibiki™ community access provided by the Speedus Corporation of New York, N.Y. In this access, each member of the community has a client module running on their computer. This client module recognizes community access points and has the required codes to facilitate secure access to community access points. This secure access is overseen by an authentication server 24 with the help of the community portal 22. In this way a visitor's computer 18 may securely access the network 14 via the network access point 10 when in the vicinity of the network access point 10. The client module effectively acts as a firewall, or makes use of an existing firewall running on the visitor's computer 18.

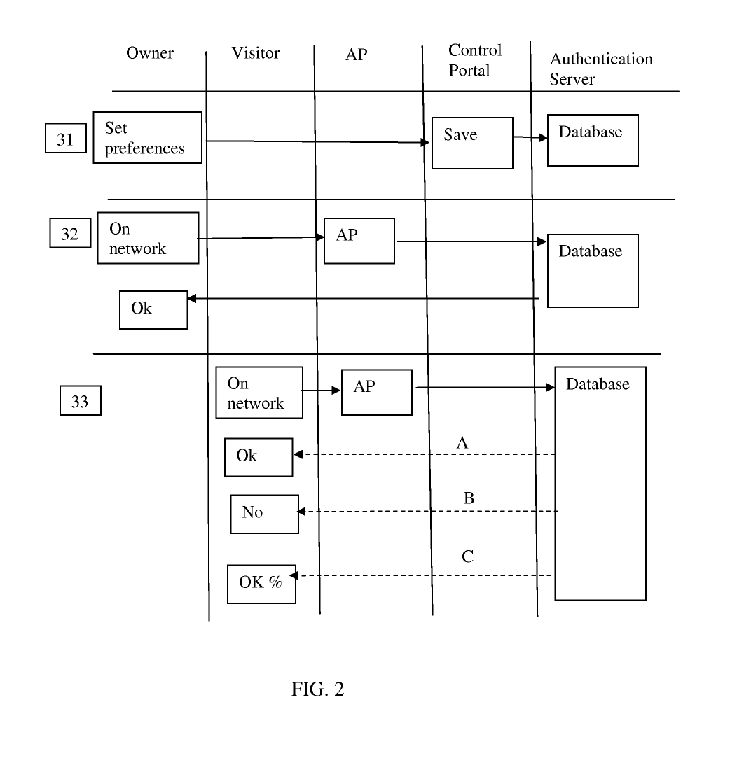

FIG. 2 shows an interaction diagram showing a schematic representation of steps involved in implementing a preferred embodiment of the present invention.

In step 31, an owner of an access point sets up preferences via a control portal 22 and an associated authentication server 24. These preferences may include setting up several classes of user with each class having specific access rights. The class of users may include, but are not limited to, the owner of the network access point 10, friends of the owner and guests who are members of the community. The access rights may include, but are not limited to, QOS guarantees such as a guarantee of 100% of the available bandwidth for the owner or any member of an access control list (ACL) at all times, 75% bandwidth guaranteed for the owner if friends access at the same time as the owner or some combination thereof.

In step 32, and an owner of the network access point 10 or one of the access control list having the same access privileges as the owner accesses the network access point 10. The request is passed on to the authentication server 24 that looks up who owns the network access point 10 and what their access control list is. The authentication server 24 then provides an “ok” to proceed to the community client module running on the owner's computer 16. This community client module obeys the instructions of the authentication server 24 and continues to provide access for the owner via the network access point 10.

In step 33, a member of the community who is not the owner or one of the access control list having the same assess privilege as the owner, access the network access point 10. Their request is passed on to the authentication server 24. After consulting the database, the authentication server 24 may issue one of three types of instructions to the community client module running on the visitor's computer 18.

In response A, if the owner or a member of the ACL is not currently using the network access point 10, the authentication server 24 will issue an “ok” command. The community client module running on the visitor's computer 18 will obey this command and allow the guest using the visitor's computer 18 access to the network 14 via the network access point 10.

In response B, if the owner or a member of the ACL is currently using the network access point 10, the authentication server 24 will issue an “no” command. The community client module running on the visitor's computer 18 will obey this command and, acting like a firewall or making use of an existing firewall on visitor's computer 18, will not allow the guest using the visitor's computer 18 continued access to the network 14 via the network access point 10. This may be accomplished by, for instance, the community client module causing the wireless connection to be dropped.

In response B, if the owner or a member of the ACL is currently using the network access point 10, but the owners preference is to achieve QOS guarantee by bandwidth throttling rather than an outright ban of shared use, the authentication server 24 will issue an “ok” command with a bandwidth limit value. The community client module running on the visitor's computer 18 will obey this command and will allow the guest using the visitor's computer 18 access to the network 14 via the network access point 10, but will monitor the bandwidth use and ensure that the visitor's computer 18 does not exceed the owner defined bandwidth value.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed:

1. A method of sharing secure access to a wireless access point, said method comprising the steps of:
generating a preferred member list comprising identities of one or more preferred members;
defining a restricted level of access available on said wireless access point to a user not on said preferred member list when a user on said preferred member list is using said wireless access point;
storing said preferred member list and said level of access on an authentication server remote to said wireless access point;
detecting access to said wireless access point by a first user;
detecting access to said wireless access point by a second user;
determining whether said first user is one of said preferred members;
determining, in the event said first member is one of said preferred members, whether said second user is one of said preferred members; and,
notifying said second user of said restricted level of access in the event said second user is not one of said preferred members and said first user is one of said preferred members.

2. The method of claim 1 wherein said step of notifying said second user to said restricted level of access comprises issuing a command by said authentication server to a client software module running on a communications device used by said second user to access said wireless access point.

3. The method of claim 2 wherein said restricted level of access comprises a bandwidth limit value.

4. The method of claim 3 wherein said bandwidth limit value is in the range of 0 to 80% of an available bandwidth of said wireless access point.

5. The method of claim 4 wherein said bandwidth limit value is in the range of 0 to 20% of said available bandwidth of said wireless access point.

6. The method of claim 2 further comprising the steps of generating a second preferred member list comprising identities of one or more second tier preferred members; defining a second restricted level of access available on said wireless access point to a user on said second preferred member list when a user on said preferred member list is using said wireless access point; and notifying said second user of said second restricted level of access in the event said second user is one of said second tier preferred members and said first user is one of said preferred members.

7. The method of claim 2 wherein said restricted level of access comprises a prohibition of peer-to-peer connections.

8. A method of sharing secure access to a wireless access point, said method comprising the steps of:
providing a preferred member list comprising identities of one or more preferred members;
providing a restricted level of access available on said wireless access point to a user not on said preferred member list when a user on said preferred member list is using said wireless access point;
accessing said wireless access point by a first user who is not a preferred member;
limiting access to said wireless access point by said first user to said restricted level of access responsive to a notification of on-going use of said wireless access point by a second user who is a preferred member.

9. The method of claim 8 wherein said step of limiting said first user to said restricted level of access comprises obeying, by a client software module running on a communications device used by said first user to access said wireless access point, a command issued by an authentication server remote to said wireless access point.

10. The method of claim 9 wherein said restricted level of access comprises a bandwidth limit value.

11. The method of claim 10 wherein said bandwidth limit value is in the range of 0 to 50% of an available bandwidth of said wireless access point.

12. The method of claim 8 wherein said restricted level of access comprises a prohibition of peer-to-peer connections.

13. A system for sharing secure access to a wireless access point, said system comprising:
a preferred member list comprising identities of one or more preferred members;
a predetermined restricted level of access available on said wireless access point to a user who is not one of said preferred members when a user who is one of said preferred members is using said wireless access point; and
an authentication server remote to said wireless access point having a storage module containing said preferred member list and said restricted level of access and a privilege module capable of detecting access to said wireless access point by a first user and a second user, determining whether said first user is one of said preferred members and whether said second user is one of said preferred members, and, of notifying, in the event said second user is not one of said preferred members and said first user is one of said preferred members, a client software module running on a communications device used by said second user to access said wireless access point of said restricted level of access.

14. The system of claim 13 wherein said client software module running on a communications device used by said second user limits access to said wireless access point to said predetermined restricted level of access.

15. The system of claim 14 wherein said restricted level of access comprises a bandwidth limit value.

16. The system of claim 15 wherein said bandwidth limit value is in the range of 0 to 40% of an available bandwidth of said wireless access point.

18. The system of claim 13 further comprising the a second preferred member list comprising identities of one or more second tier preferred members; a second predefined restricted level of access available on said wireless access point to a user on said second preferred member list when a user on said preferred member list is using said wireless access point; and in the event said second user is one of said second tier preferred members and said first user is one of said preferred members, notifying said client software module running on a communications device used by said second user second user of said second restricted level of access.

19. The system of claim 13 wherein said restricted level of access comprises a prohibition of peer-to-peer connections.
